(19) United States
(12) Patent Application Publication
(10) Pub. No.: US 2015/0347366 A1
(43) Pub. Date: Dec. 3, 2015

(54) CREATION OF ASSOCIATIVE 3D PRODUCT DOCUMENTATION FROM DRAWING ANNOTATION

(71) Applicant: Siemens Product Lifecycle Management Software Inc., Plano, TX (US)

(72) Inventor: Lea Irwin, Maineville, OH (US)

(73) Assignee: Siemens Product Lifecycle Management Software Inc., Plano, TX (US)

(21) Appl. No.: 14/289,063

(22) Filed: May 28, 2014

(51) Int. Cl. G06F 17/24; G06T 19/20

(52) U.S. Cl. CPC G06F 17/241; G06T 19/20; G06T 2219/004

(57) ABSTRACT

Methods for product data management and corresponding systems and computer-readable mediums are disclosed herein. A method includes receiving one or more attributes of a candidate drawing annotation of one or more drawing annotations of a drawing view. The method also includes creating a comparable 3D product documentation object using the one or more collected attributes. The method further includes identifying a 3D model view to display the 3D product documentation object. The method includes displaying the 3D product documentation object in the identified 3D model view.

### TECHNICAL FIELD

The present disclosure is directed, in general, to computer-aided design, visualization, and manufacturing systems (“CAD systems”), product lifecycle management (“PLM”) systems, and similar systems, that manage data for products and other items (collectively, “Product Data Management” systems or PDM systems).

### BACKGROUND OF THE DISCLOSURE

CAD systems are useful for designing and visualizing two-dimensional (2D) and three-dimensional (3D) models and drawings. Improved systems are desirable.

### SUMMARY OF THE DISCLOSURE

Various disclosed embodiments include a method for product data management, the method performed by a data processing system and including receiving one or more attributes of a candidate drawing annotation of one or more drawing annotations of a drawing view. The method also includes creating a comparable 3D product documentation object using the one or more received attributes. The method further includes identifying a 3D model view to display the 3D product documentation object. The method includes displaying the 3D product documentation object in the identified 3D model view.

Various disclosed embodiments also include a data processing system including a processor. The data processing system also includes an accessible memory. The data processing system is particularly configured to receive one or more attributes of a candidate drawing annotation of one or more drawing annotations of a drawing view. The data processing unit is also configured to create a comparable 3D product documentation object using the one or more received attributes. The data processing unit is further configured to identify a 3D model view to display the 3D product documentation object. The data processing unit is configured to display the 3D product documentation object in the identified 3D model view.

Various disclosed embodiments further include a non-transitory computer-readable medium encoded with executable instructions that, when executed, cause one or more data processing systems to receive one or more attributes of a candidate drawing annotation of one or more drawing annotations of a drawing view. The non-transitory computer-readable medium also causes one or more data processing systems to create a comparable 3D product documentation object using the one or more collected attributes. The non-transitory computer-readable medium further causes one or more data processing systems to identify a 3D model view to display the 3D product documentation object. The non-transitory computer-readable medium further causes one or more data processing systems to display the 3D product documentation object in the identified 3D model view.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system in which an embodiment can be implemented;

FIG. 2A illustrates an example of a drawing with one or more sheets according to this disclosure;

FIG. 2B illustrates an example of a 3D model view according to this disclosure;

FIG. 3 illustrates an example relationship between the original drawing and the 3D parts or assemblies where a new 3D product documentation object and 3D model view can be created from information on a drawing according to this disclosure;

FIG. 4 illustrates a flowchart of a process in accordance with disclosed embodiments that may be performed, for example, by a data processing system (e.g. a PLM or PDM system) in order to convert a drawing view into a 3D model view;

FIG. 5 illustrates a flowchart of a process in accordance with disclosed embodiments that may be performed, for example, by a data processing system (e.g. a PLM or PDM system) in order to convert a drawing annotation to a 3D product documentation object; and

FIG. 6 illustrates a flowchart of a process in accordance with disclosed embodiments that may be performed, for example, by a data processing system (e.g. a PLM or PDM system) in order to convert a drawing annotation object displayed on a 3D model to a 3D product documentation object.

### DETAILED DESCRIPTION

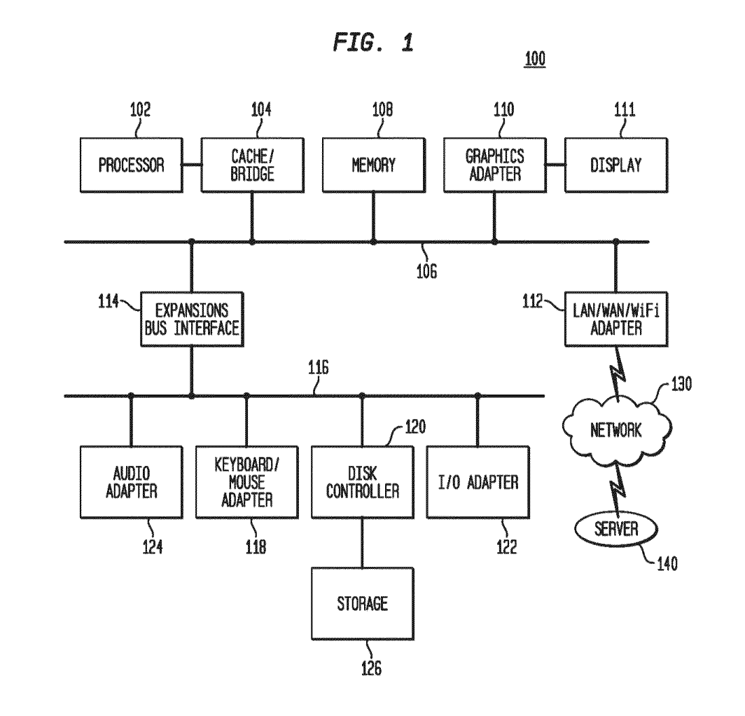

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

When converting a drawing based process to three-dimensional (3D) models and 3D product and manufacturing information (3D product documentation), a significant amount of effort and time is used to recreate the product documentation on the 3D model. Recreating the product documentation on the 3D model must be manually verified to ensure that the product documentation in the 3D model matches the product documentation from the drawing. The time and effort, as well as the cost, used to recreate product documentation from a drawing into a 3D model can impede the adoption of a 3D model based process.

Disclosed embodiments include systems and methods for creating 3D model views which can correspond to drafting view on a drawing and for creating 3D product documentation which can correspond to drafting annotation on a drawing. For example, 2D drawings which reference a 3D model can be used to create 3D model views which correspond to the drafting views on the drawing as well as 3D product documentation which corresponds to the drafting annotation on the drawing. Furthermore, various embodiments also include systems and methods for indicating and reporting drafting objects which were not able to be converted to 3D.

FIG. 1 illustrates a block diagram of a data processing system in which an embodiment can be implemented, for example as a CAD or PDM system particularly configured by software or otherwise to perform the processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. Wi-Fi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, track pointer, touchscreen, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

In an embodiment, the data processing system (e.g. a CAD, PLM, or PDM system) can be used to create 3D product documentation objects (such as 3D production and manufacturing information (PMI) objects) and 3D model views of a 3D model from 2D drawings. 3D product documentation objects and 3D model views can be created in a variety of contexts, for example, based on how the conversion process is used. The data processing system can be configured to support layer management, drawing (or drafting) objects which can be excluded from a conversion to a 3D model, and multi-CAD assemblies where the components can be defined by CAD definition derivative files (such as JT files).

Some systems can support the creation of drafting (or drawing) annotation objects on a 3D model by entering the drafting application and disabling the display of the drawing sheet. This process can allow the creation of all types of drafting annotation in the 3D model views and can be used to create product documentation on a 3D model prior to the development of the 3D product documentation object tools. However, such drafting annotation displayed on the 3D model does not provide any of the 3D product documentation object capabilities. For example, definitions of associated objects on the model which capture the design intent of the 3D product documentation object. 3D Product documentation associated objects can also be highlighted when the 3D product documentation object is selected to easily identify an affected portion(s) of the model. As another example, 3D product documentation objects can be included in a directory of the 3D model content. 3D product documentation objects presented in the directory of the 3D model contents (such as a part navigator) can make it easy to see which 3D model views the 3D product documentation objects are displayed in, which 3D product documentation objects are defined on the model, the details of the 3D product documentation objects and the associations of the 3D product documentation objects to other objects on the part. As yet another example, 3D product documentation objects can be used to export and import files in a visualization format as well as operate with 2D to 3D conversion programs.

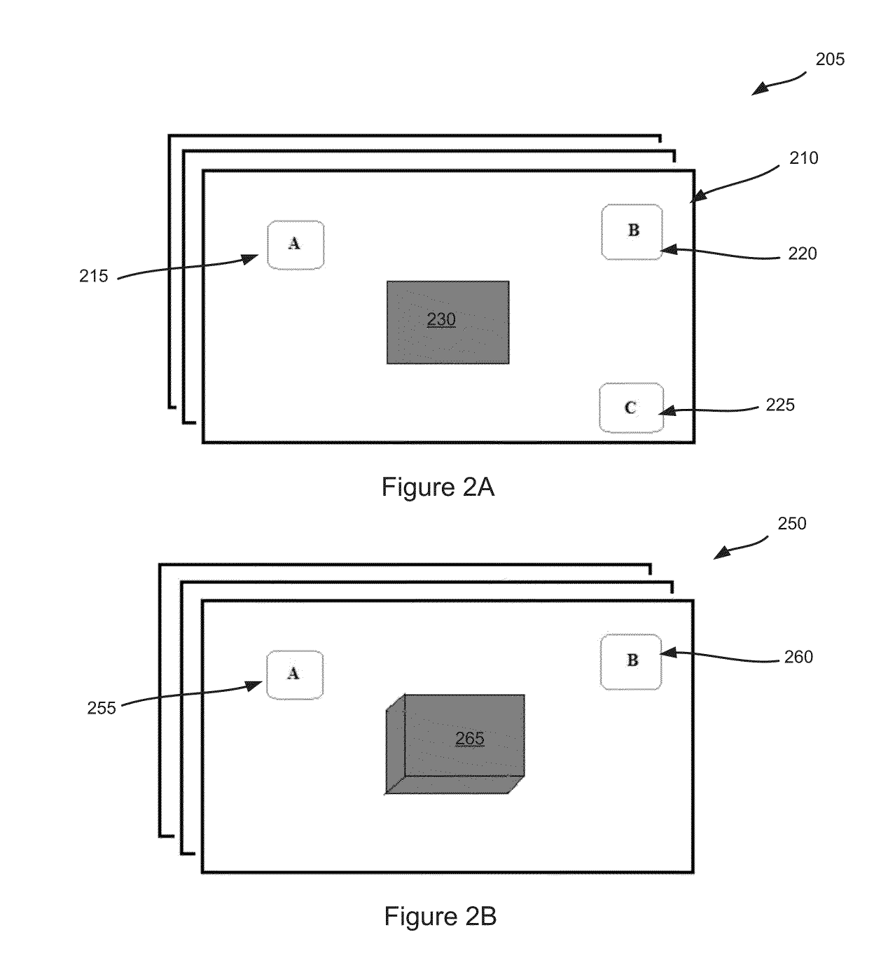

Generally, the following data can be used by various disclosed embodiments when initiating a process of converting a drawing with views into 3D model views or converting a drawing with annotation objects into 3D model views with 3D product documentation objects: drawings with correlating 3D models which include one or more sheets, one or more views, and one or more drawing annotations can be used to create a 3D model view that corresponds to a view in a drawing. For example, FIG. 2A illustrates an example of a drawing 205 with one or more sheets 210 according to this disclosure. The drawing 205 with the one or more sheets 210 can be created from a 3D model and can include one or more annotation objects 215, 220, and 225. The one or more annotation objects can indicate features or characteristics of an object 230 depicted in the drawing 205. In an embodiment, annotation objects 215 and 220 can be candidate annotation objects capable of being converted to 3D product documentation objects, such that while element 225 is an annotation object, it is not a candidate annotation object and thus not capable of conversion. As disclosed herein, the one or more sheets 205 and the one or more candidate annotation objects 215 and 220 of the one or more sheets 210 can be converted to 3D model views containing 3D product documentation objects.

For example, FIG. 2B illustrates an example of a 3D model view 250 according to this disclosure. The 3D model view 250 can be created from a drawing view 205 or a 3D model and can include one or more 3D product documentation objects 255 and 260. In an embodiment, the one or more 3D product documentation objects 255 and 260 can be generated from candidate annotation objects 215 and 220. The 3D model 265 can be a 3D model of the object 230 depicted in the 2D drawing 205. The 3D product documentation objects 255 and 260 correlate with features or characteristics of a 3D model 265.

In an embodiment, 3D product documentation objects can be correlated to annotation objects by describing, referencing, or specifying the same one or more requirements from a 2D drawing in a 3D model view. For example, 3D product documentation objects can include height, length, and thickness of a part in a 3D model view, a relationship between two or more parts in a 3D model view, a material type of a part, and otherwise provided from a 2D drawing. An annotation object can be a static visual representation which can be interpreted or re-entered into other systems. The annotation object can be selected and highlighted, but cannot provide information about the geometry to which it pertains. A 3D product documentation object can be integrated with the 3D CAD models and can enable the explicit indication of the design intent. For example, when 3D product documentation objects are selected, the selected 3D product documentation object can highlight the geometry to which it pertains.

In an embodiment, 3D product documentation objects can have an associative relationship with a 3D model. For example, 3D product documentation object 260 can provide information related to the depth of the 3D model 265. While in the 3D model view, the depth of the 3D model 265 can be increased. As such because the 3D product documentation object 260 has an associative relationship with the 3D model 265, after the depth of the 3D model has been increased, the 3D product documentation object 260 can update to provide information related to the new depth of the 3D model 265. In an embodiment, if specific feature of a 3D model, such as 3D model 265, becomes unavailable (such as because of deletion from the 3D model), then the 3D product documentation object 260 can indicate that information related to a deleted feature is no longer available. Alternatively, if specific feature of a 3D model, such as 3D model 265, becomes unavailable (such as because of deletion from the 3D model), then the 3D product documentation object 260 can also become unavailable or can be deleted.

In an embodiment, a drawing view can be a 2D view of a part or an assembly. Drawing annotations in the drawing view can provide information relating to the size, composition, dimensions, or any other information related to the part or assembly provided in the drawing view. Furthermore, a 3D model view can be a view of a 3D model, for example, of a part or an assembly. 3D product documentation objects in the 3D model view can provide information relating to the size, composition, dimensions, or any other information related to the part or assembly provided in the 3D model view.

The data processing system can use a variety of methods to initiate the conversion process. In an embodiment, a user can initiate the conversion process by selecting individual annotation objects 215 and 220 to be inserted into a 3D model view (e.g. by providing a user input to the data processing system). In this case, a user can choose to select none, some, or all of the annotation objects 215 and 220 and convert those selected annotation objects 215 and 220 into 3D product documentation objects in a 3D model view of a 3D model.

Conversely, an automated process can be used to initiate the conversion process. For example, instead of a user selecting individual candidate annotation objects 215 and 220 for conversion, an automated process can programmatically supply the drawing data. In an embodiment, the automated process can select or specify a drawing in which all candidate annotation objects 215 and 220 on the drawing are converted to 3D product documentation objects in a 3D model view. For example, an automated process can select all candidate annotation objects 215 and 220 from all of the sheets of a drawing, all of the views from each sheet, and each of the annotation objects (e.g. candidate annotation objects) found in the view, related to the views, and on the sheets.

In another embodiment, the automated process can select or specify one or more sheets on a drawing in which case all candidate annotation objects 215 and 220 on the sheet are converted. This can include all of the views on the one or more sheets and each of the candidate annotation objects 215 and 220 found in the views, related to the view, or on the one or more sheets. Furthermore, in yet another embodiment, the automated process can select or specify a drawing view on a sheet of a drawing in which case all candidate annotation objects 215 and 220 on the drawing view are converted. This can include each of the candidate annotation objects 215 and 220 found in the view or related to the view.

In yet another embodiment, the automated process can select annotation objects 215, 220, and 225 on a drawing 205 in which case the candidate annotation objects 215 and 220 among those selected are converted.

In an embodiment, the data processing system can also report the status of the conversion process. The data processing system can report the success of the conversion process as well as identify annotation objects which could not be converted. For example, the data processing system can report the success of the conversion process and generate a report for display containing information. The generated report can display specific annotation objects which were not converted because they did not meet one or more criteria for view or annotation type as will be disclosed further herein. The generated report can also display specific annotation objects (such as candidate annotation objects) which were not converted because the conversion process encountered an error. The generated report can further display statistics on the number and type of annotation objects successfully converted. Furthermore, the generated report can display data on objects which were successfully converted. In an embodiment, reporting can include providing information related to a number of views converted, which views were converted, a number views not converted, which views were not converted, a number of annotations converted, which annotations were converted, a number of annotations not converted, and which annotations were not converted.

In an embodiment, a new 3D product documentation object and 3D model view can be created using the 3D model from which the drawing was created. For example, the 3D model can be a 3D model of a piece part or an assembly. The 3D model can also be a 3D model of the same part as from which the drawing was created or it can be a separate part which contains the 3D model geometry. In another embodiment, a new 3D product documentation object or 3D model view of a component of an assembly can be created when the drawing view is a view from the component rather than a view from the assembly. A 3D model view and new 3D product documentation object can be created in the assembly or a component of the assembly as appropriate.

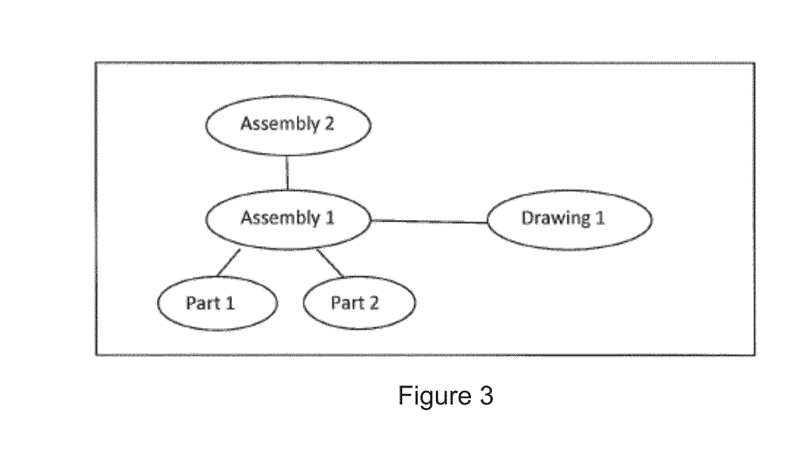

A new 3D product documentation object and 3D model view can also be created in a parent assembly of a 3D model from which the drawing was created. FIG. 3 illustrates an example relationship between the original drawing and the 3D parts or assemblies where a new 3D product documentation object and 3D model view can be created from information on a drawing according to this disclosure. As illustrated in FIG. 3, the part or assembly that corresponds to the drawing can be represented by “Assembly 1”. However, for some special cases it may be necessary to be able to create the 3D model views and 3D product documentation objects in an assembly which is the immediate parent of the corresponding part or assembly. As illustrated in FIG. 3 the immediate parent of the corresponding part or assembly can be represented by “Assembly 2”.

In an embodiment, a drawing view with annotation objects can be converted into a 3D model view, for example, before the annotation objects of the drawing view are converted into product documentation objects.

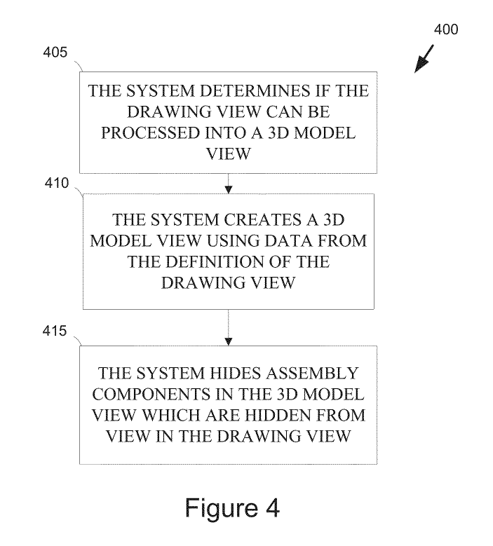

FIG. 4 illustrates a flowchart of a process 400 in accordance with disclosed embodiments that may be performed, for example, by a data processing system (e.g. a PLM or PDM system) in order to convert a drawing view into a 3D model view. At step 405, the data processing system can determine if the drawing view can be processed into a 3D model view. In an embodiment, in order to determine if the drawing view can be processed into a 3D model view, the system can determine if a view is of the 3D model that correlates to the drawing. For example, views created solely on the drawing independent of a 3D model may not be processed. In an embodiment, in order to determine if the drawing view can be processed into a 3D model view, the system can determine if the drawing view is of a type which can be mapped to a 3D model view. In an embodiment, standard views can be processed into a 3D model view. Furthermore, other types of drawing views which can be created in 3D can also include, but are not limited to the following types listed below in Table 1.

TABLE 1

| Drawing View | 3D Model View |
|---|---|
| Base View | Standard View |
| Top | Top |
| Front | Front |
| Right | Right |
| Back | Back |
| Bottom | Bottom |
| Left | Left |
| Isometric | Isometric |
| Trimetric | Trimetric |
| Standard View - Base View | Standard View |
| Top | Top |
| Front | Front |
| Right | Right |
| Left | Left |
| Isometric | Isometric |
| Projected View | User Defined View |
| Detail View | User Defined View |
| Section | |
| Simple | Section View |
| Stepped | Section View |
| Half Section | Section View |
| Pictorial | Section View |
| Half Pictorial | Section View |
| Break-Out | Section View |

At step 410, the data processing system can create a 3D model view using data from the definition of the drawing view.

In an embodiment, the 3D model view can have an orientation obtained from the drawing view. For example, the 3D model view can be oriented so that the 3D model is viewed from the same direction as it is in the drawing view, such as when the 3D model view is displayed in its “as defined” state. In an embodiment, a “zoom factor” or scale of the 3D model view can be derived from the drawing view. The “zoom factor” or scale of the 3D model view can be set so that the presentation of the 3D model view corresponds, as close as possible, to the drawing view, for example, such as when the 3D model view is displayed in its “as defined” state.

At step 415, the data processing system can hide assembly components in the 3D model view which are hidden from view in the drawing view.

In some embodiments, in order to convert a drawing view into a 3D model view, the system can examine individual section views from the drawing. For planar sections, the system can determine the placement and orientation of the section plane based on the placement and orientation of section line on the drawing view. The display type of the section can be set based on the setting from the drawing section view. For example, the settings from the drawing section view can be “section” or “plane-only”. For a stepped offset section, the system can create an appropriate section in a 3D model view that has appropriate placement and orientation derived from only one drawing section line of the drawing view. In an embodiment, if a limited number of components are cut in the drawing section view, only those same components can be cut in the 3D model section view.

However, in various embodiments, once a drawing view with annotation objects is converted into a 3D model view, the annotation objects of the drawing view can be converted into 3D product documentation objects for insertion into the 3D model view. In an embodiment, new 3D product documentation objects can also be added to the 3D model view regardless of whether the drawing view contained annotation objects.

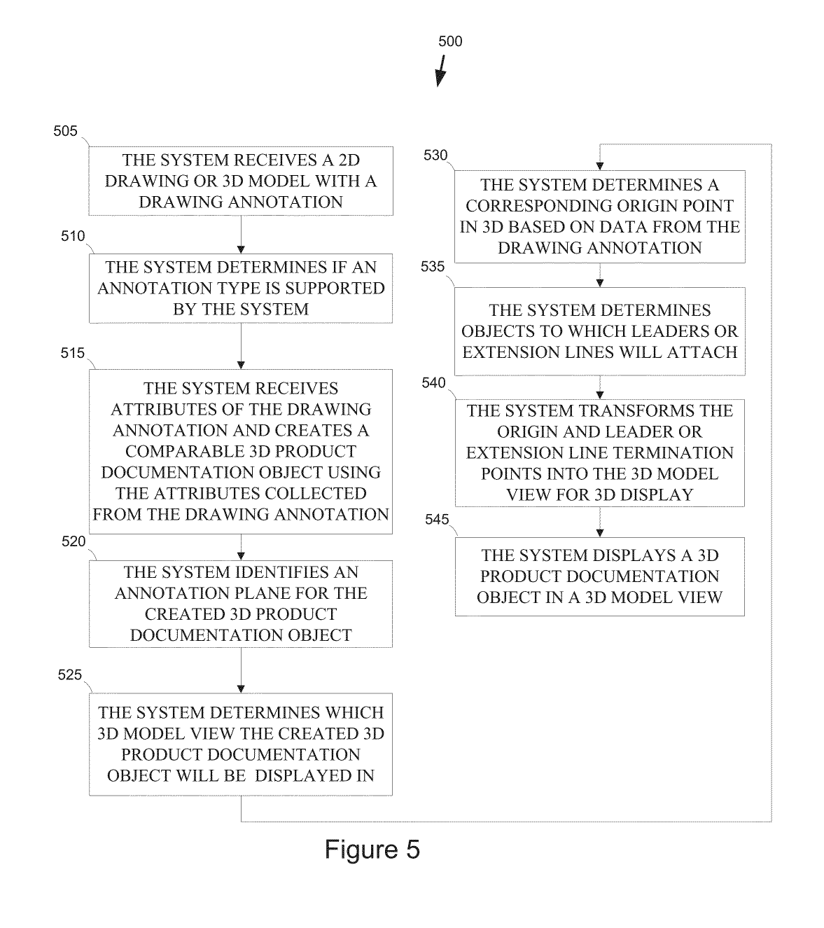

FIG. 5 illustrates a flowchart of a process 500 in accordance with disclosed embodiments that may be performed, for example, by one or more data processing systems (e.g. a CAD, PLM, or PDM system) in order to convert a drawing annotation to a 3D product documentation object. At step 505, the data processing system can receive a 2D drawing, a 3D model, a 3D model view, or the like with a drawing annotation. Receiving, as used herein, can include loading from storage, receiving from another device or process, receiving via an interaction with a user, or otherwise.

At step 510, the data processing system can determine if an annotation type of the drawing annotation is supported by the system. In an embodiment, the data processing system can support all annotation types including standard annotation types. Table 2, illustrated below, provides a list of some example annotation types that can be supported by the system.

TABLE 2

| Drawing Annotation | product documentation |
|---|---|
| Dimensions | Dimensions |
| Horizontal | Horizontal |
| Vertical | Vertical |
| Parallel | Parallel |
| Perpendicular | Perpendicular |
| Chamfer | Chamfer |
| Angular | Angular |
| Cylindrical | Cylindrical |
| Hole | Hole |
| Diameter | Diameter |
| Radius | Radius |
| Radius to Center | Radius to Center |
| Folded Radius | Folded Radius |
| Arc Length | Arc Length |
| Perimeter | Perimeter |
| Thickness | Thickness |
| Arc Length | Arc Length |
| Horizontal Chain | Horizontal Chain |
| Vertical Chain | Vertical Chain |
| Horizontal Baseline | Horizontal Baseline |
| Vertical Baseline | Vertical Baseline |
| Ordinate | Ordinate |
| Ordinate Origin | Ordinate Origin |
| Dimension Sets | Dimension Sets |
| Callout | Callout |
| Note | Note |
| Feature Control Frame | Feature Control Frame |
| Datum Feature Symbol | Datum Feature Symbol |
| Datum Target | Datum Target |
| Balloon | Balloon |
| Surface Finish Symbol | Surface Finish Symbol |
| Weld Symbol | Weld |
| Custom Symbol | Custom Symbol |
| Centerlines | |
| Center Mark | Center Mark |
| 3D Centerline | 3D Centerline |

At step 515, the data processing system can receive the attributes of the drawing annotation and create a comparable 3D product documentation object using the attributes collected from the drawing annotation. In an embodiment, system preferences can allow a user to override one or more display attributes as needed.

At step 520, the data processing system can identify or determine an annotation plane for the created 3D product documentation object. For example, a 3D model view can be chosen for display. The system can then identify an annotation plane chosen for display. In an embodiment, the system or a user can select an annotation plane and subsequently identify an inferred annotation plane based on the selected annotation plane.

At step 525, the data processing system can determine which 3D model view the created 3D product documentation object will be displayed in. For example, if the drawing annotation is dependent on a drawing view, the 3D model view which corresponds to the drawing view can be used. In another example, if the drawing annotation is on a drawing sheet but has a leader which terminates in a known drawing view, the 3D model view which corresponds to the drawing view can be used. In yet another example, if the drawing annotation has a leader or extension lines and if the terminating point of the leader or extension line lies within the boundary of a drawing view, the 3D model view which corresponds to the drawing view can be used. In another example, if a drawing annotation has leaders or extension lines that terminate in more than one drawing view, one of the drawing views can be selected. In still yet another example, if no drawing view has yet to be determined, the 3D product documentation can be placed in a default 3D model view or in a 3D model view which has been created to hold drawing annotation on the sheet which has no connection to a drawing view.

At step 530, the data processing system can determine a corresponding origin point for the 3D product documentation in 3D based on data from the drawing annotation. In an embodiment, the system can also determine a corresponding origin point in 3D for the 3D product documentation based on data from the drawing annotation and the target 3D model view.

At step 535, the data processing system can determine objects to which leaders or extension lines will attach. In an embodiment, if the drawing annotation is attached to geometry which has a counterpart in 3D, the 3D geometry that corresponds to the 2D geometry to which the 2D drafting annotation is attached can be used as the attached geometry for the 3D product documentation object. However, if the drawing annotation is not attached to geometry which has a counterpart in 3D, for example, such that the drawing annotation terminates at some point on the sheet, then the system can project a vector from the point of the leader or extension line terminator onto the geometry in the drawing view. The system can filter for appropriate types of geometry which can include faces, edges, curves, and the like.

At step 540, the data processing system can transform the origin and leader or extension line termination points into the 3D model view for 3D display.

At step 545, the data processing system can display a 3D product documentation object in a 3D model view on a display or store in a storage medium a 3D product documentation object converted from a drawing annotation within a 3D model view.

In an embodiment, one or more features of the 3D model depicted in the 3D model view can be changed or deleted. Accordingly, after the one or more features of the 3D model are changed, one or more 3D product documentation objects associated with the changed feature can update to provide information related to the change. Further after one or more features of the 3D model are deleted, one or more 3D product documentation objects associated with the deleted one or more features can indicate the information related to the one or more deleted features are no longer available. Alternatively, after one or more features of the 3D model are deleted, the 3D product documentation objects associated with the one or more deleted features can also be deleted. In an embodiment, all leader points, 3D product documentation object origins, and otherwise can also be updated in response to changes in size, placement, orientation, and otherwise of a 3D model in a 3D model view.

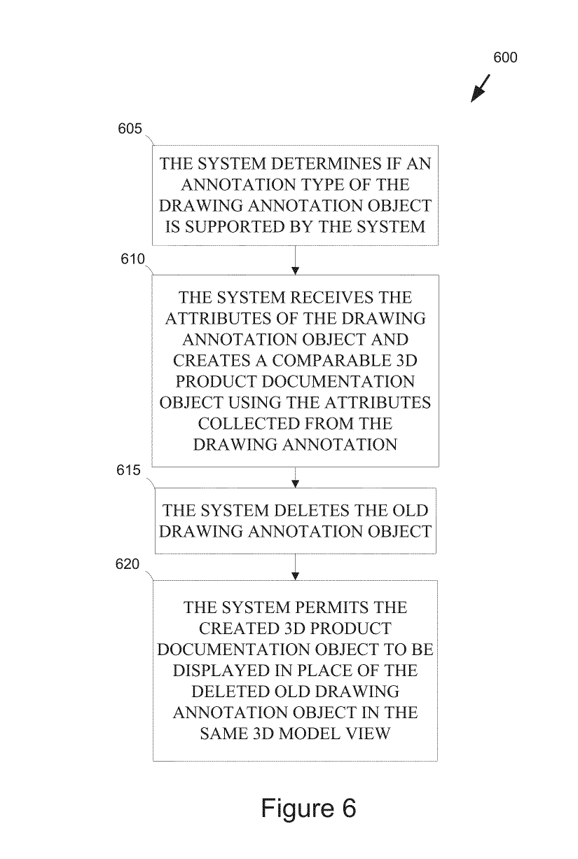

FIG. 6 illustrates a flowchart of a process 600 in accordance with disclosed embodiments that may be performed, for example, by one or more data processing systems (e.g. a CAD, PLM, or PDM system) in order to convert a drawing annotation object displayed on a 3D model to a 3D product documentation object. At step 605, similar to other embodiments disclosed herein, the data processing system can determine if an annotation type of the drawing annotation object is supported by the system. In an embodiment, all annotation types can be supported by the system.

At step 610, the data processing system can receive the attributes of the drawing annotation object and create a comparable 3D product documentation object using the attributes collected from the drawing annotation. In an embodiment, system preferences can allow a user to override one or more display attributes as needed.

At step 615, the data processing system can delete the old drawing annotation object. For example, the system may determine that the old drawing annotation either will overlap with the to be added 3D product documentation objects when displayed or will provide information that would duplicate the information to be provided by the added 3D product documentation objects when displayed. As such, the system can delete old drawing annotation objects to prevent overlap or the duplication of information. At step 620, the system can permit the created 3D product documentation object to be displayed in place of the deleted old drawing annotation object in the same 3D model view.

In some cases, drawing annotation objects can be displayed in a 3D model. As such, drawing annotation in the 3D model can be converted into 3D product documentation objects.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke 35 USC §112(f) unless the exact words “means for” are followed by a participle.

What is claimed is:

1. A method for product data management, the method performed by a data processing system and comprising:
receiving one or more attributes of a candidate drawing annotation of one or more drawing annotations of a drawing view;
creating a comparable 3D product documentation object using the one or more received attributes;
identifying a 3D model view to display the 3D product documentation object; and
displaying the 3D product documentation object in the identified 3D model view.

2. The method of claim 1, further comprising updating the 3D product documentation object in response to changing one or more features of a 3D model depicted in the 3D model view, wherein the 3D product documentation object is associated with the one or more features of the 3D model depicted in the 3D model view.

3. The method of claim 1, wherein identifying the 3D model view to display the 3D product documentation object comprises identifying the 3D model view that corresponds to the drawing view including the candidate drawing annotation if the candidate drawing annotation is dependent on the drawing view.

4. The method of claim 1, further comprising creating a 3D model view configured to support the candidate drawing annotation on a sheet which has no connection to the drawing view.

5. The method of claim 1, wherein the 3D model view is created from the drawing view including the candidate drawing annotation.

6. The method of claim 1, further comprising creating the 3D model view from the drawing view.

7. The method of claim 6, further comprising generating and displaying a report indicating a status of a conversion of the candidate drawing annotation to the 3D product documentation object, wherein generating and displaying the report comprises: identifying if the candidate drawing annotation was converted to a 3D product documentation object and displayed in the 3D model view;
identifying the number and type of total candidate drawing annotations which were converted to 3D product documentation objects and displayed in the 3D model view;
providing data related to which of the total candidate drawing annotations were successfully converted to 3D product documentation objects; and
providing data related to which drawing views were successfully and unsuccessfully converted to 3D model views.

8. A data processing system comprising:
a processor; and
an accessible memory, the data processing system particularly configured to:
receive one or more attributes of a candidate drawing annotation of one or more drawing annotations of a drawing view;
create a comparable 3D product documentation object using the one or more received attributes;
identify a 3D model view to display the 3D product documentation object; and
display the 3D product documentation object in the identified 3D model view.

9. The data processing system of claim 8, wherein the data processing system is further particularly configured to update the 3D product documentation object in response to a change to one or more features of a 3D model depicted in the 3D model view, wherein the 3D product documentation object is associated with the one or more features of the 3D model depicted in the 3D model view.

10. The data processing system of claim 8, wherein the data processing system is further particularly configured to identify the 3D model view that corresponds to the drawing view including the candidate drawing annotation if the candidate drawing annotation is dependent on the drawing view.

11. The data processing system of claim 8, wherein the data processing system is further particularly configured to create the 3D model view to support the candidate drawing annotation on a sheet which has no connection to the drawing view.

12. The data processing system of claim 8, wherein the 3D model view is created from the drawing view including the candidate drawing annotation.

13. The data processing system of claim 8, wherein the data processing system is further particularly configured to create the 3D model view from the drawing view.

14. The data processing system of claim 13, wherein the data processing system is further particularly configured to:
generate and display a report indicating a status of a conversion of the candidate drawing annotation to the 3D product documentation object;
identify if the candidate drawing annotation was converted to a 3D product documentation object and displayed in the 3D model view;
identify the number and type of total candidate drawing annotations which were converted to 3D product documentation objects and displayed in the 3D model view;
provide data related to which of the total candidate drawing annotations were successfully converted to 3D product documentation objects; and
provide data related to which drawing views were successfully and unsuccessfully converted to 3D model views.

15. A non-transitory computer-readable medium encoded with executable instructions that, when executed, cause one or more data processing systems to:
receive one or more attributes of a candidate drawing annotation of one or more drawing annotations of a drawing view;
create a comparable 3D product documentation object using the one or more received attributes;
identify a 3D model view to display the 3D product documentation object; and
display the 3D product documentation object in the identified 3D model view.

16. The computer-readable medium of claim 15, wherein the one or more data processing systems are further particularly configured to update the 3D product documentation object in response to a change to one or more features of a 3D model depicted in the 3D model view, wherein the 3D product documentation object is associated with the one or more features of the 3D model depicted in the 3D model view.

17. The computer-readable medium of claim 15, wherein the one or more data processing systems are further particularly configured to identify the 3D model view that corresponds to the drawing view including the candidate drawing annotation if the candidate drawing annotation is dependent on the drawing view.

18. The computer-readable medium of claim 15, wherein the 3D model view is created from the drawing view including the candidate drawing annotation.

19. The computer-readable medium of claim 15, wherein the one or more data processing systems are further particularly configured to create the 3D model view from the drawing view.

20. The computer-readable medium of claim 19, wherein the one or more data processing systems are further particularly configured to:
generate and display a report indicating a status of a conversion of the candidate drawing annotation to the 3D product documentation object;
identify if the candidate drawing annotation was converted to a 3D product documentation object and displayed in the 3D model view;
identify the number and type of total candidate drawing annotations which were converted to 3D product documentation objects and displayed in the 3D model view;
provide data related to which of the total candidate drawing annotations were successfully converted to 3D product documentation objects; and
provide data related to which drawing views were successfully and unsuccessfully converted to 3D model views.
